(19) United States
(12) Patent Application Publication
(10) Pub. No.: US 2004/0217684 A1
(43) Pub. Date: Nov. 4, 2004

(54) Color cathode ray tube

(76) Inventors: Jae Wook Lee, Gumi-si (KR); Min Ho Lim, Daegukwangyuk-si (KR)

Correspondence Address: BIRCH STEWART KOLASCH & BIRCH, PO BOX 747, FALLS CHURCH, VA, 22040-0747, US

(21) Appl. No.: 10/761,383

(22) Filed: Jan. 22, 2004

(30) Foreign Application Priority Data
Jan. 23, 2003 (KR) 10-2003-0004467

(51) Int. Cl. H01J 61/30; H01J 31/00; H01K 1/28

(52) U.S. Cl. 313/477 R; 220/2.1 R

(57) ABSTRACT

The present invention relates to a color cathode ray tube and more specifically to a color cathode ray tube having a panel structure which provide characteristic of explosion proof while cutting down on expences and weight.

A cathode ray tube according to an embodiment 1 of the present invention comprising: a panel having an effective screen; a funnel connected to the panel; and an electron gun to generate electron beams; wherein said effective screen has a horizontal and vertical ratio of 16:9; and said panel satisfies a condition: [(Δy/d)×100]≦5.65, wherein d is length from a central point G to a diagonal vertex E of said effective screen, and Δy is length from a point H to an intersection point of the outline of the panel and the shorter axis Y, the point H being intersection of shorter axis Y and a longer side of said effective screen.

### TECHNICAL FIELD

The present invention relates to a color cathode ray tube and more specifically to a color cathode ray tube having a panel structure which provide characteristic of explosion proof while cutting down on expences and weight.

### BACKGROUND OF THE INVENTION

FIG. 1 shows a schematic diagram illustrating the structure of a general color cathode ray tube. As shown in FIG. 1, the color cathode ray tube generally includes a glass envelope having a shape of bulb and being comprised of a faceplate panel 2 to which explosion prevention means is fixed, a tubular neck, and a funnel 3 connecting the panel 2 and the neck. A phosphor screen 7 is formed on the inner surface of the faceplate panel 2. The phosphor screen 7 is coated by phosphor materials of R, G, and B.

A multi-apertured color selection electrode, i.e., shadow mask 8 is mounted to the panel 2. The shadow mask 8 is hold by a peripheral frame 9. An electron gun 6 is mounted within the neck to generate and direct electron beams 5 along paths through the mask to the panel 2.

The cathode ray tube further comprises an inner shield 12 for shielding the tube from external geomagnetism. The inner shield 12 is joined to the frame 9. Further, a spring 10 for combining the frame 9 and the funnel 3 is joined to the frame 9.

The operation of the general cathode ray tube will be described shortly referring to FIG. 1.

The electron beams 5, which are radiated from the electron gun 6 by the voltage applied to the cathode ray tube, impinge upon the phosphor screen 7. The electron beams 5 are deflected in either vertical and horizontal directions by the deflection yokes 13. Furthermore, trajectory of the electron beams 5 are corrected by magnet to impinge upon a desired location on the phosphor screen 7. With the magnet, color purity is improved.

Recently, a color cathode ray tube is getting larger in size and becomes to have wide angle. As color cathode ray tube is getting larger in size, the explosion of the panel or the funnel by external shock increases accordingly. Therefore, the structure of a color cathode ray tube becomes important.

In this regard, a reinforcing band 15 is attached to the sidewall portion of the panel 2 to reinforce strength of the panel or the funnel. Also, corners of the panel 2 are designed to have a predetermined curvature to prevent the cathode ray tube from being exploded by external shock.

Accordingly, In the conventional color cathode ray tube, the weight and cost of the panel account for 50 percent of overall weight and cost of the color cathode ray tube.

For example, in the conventional color cathode ray tube having an effective diagonal diameter of 68 cm and a vertical and horizontal ratio of 16:9 for an effective screen, the weight and cost of the panel account for 40 and 60 percent of overall weight and cost of the color cathode ray tube, respectively.

### SUMMARY OF THE INVENTION

An object of the present invention is to provide a color cathode ray tube having a panel structure which provide characteristic of explosion proof while cutting down on expences and weight.

A cathode ray tube according to an embodiment 1 of the present invention comprising: a panel having an effective screen; a funnel connected to the panel; and an electron gun to generate electron beams; wherein said effective screen has a horizontal and vertical ratio of 16:9; and said panel satisfies a condition: [(Δy/d)×100]≦5.65, wherein d is length from a central point G to a diagonal vertex E of said effective screen, and Δy is length from a point H to an intersection point of the outline of the panel and the shorter axis Y, the point H being intersection of shorter axis Y and a longer side of said effective screen.

A cathode ray tube according to embodiment 2 of the present invention comprising: a panel having an effective screen; a funnel connected to the panel; and an electron gun to generate electron beams; wherein said effective screen has a horizontal and vertical ratio of of 4:3; and said panel satisfies a condition: [(Δy/d)×100]≦5.05, wherein d is length from a central point G to a diagonal vertex E of said effective screen, and Δy is length from a point H to an intersection point of the outline of the panel and the shorter axis Y, the point H being intersection of shorter axis Y and a longer side of said effective screen.

### BRIEF DESCRIPTION OF THE DRAWINGS

FIG. 1 shows a schematic diagram illustrating the structure of a general color cathode ray tube.

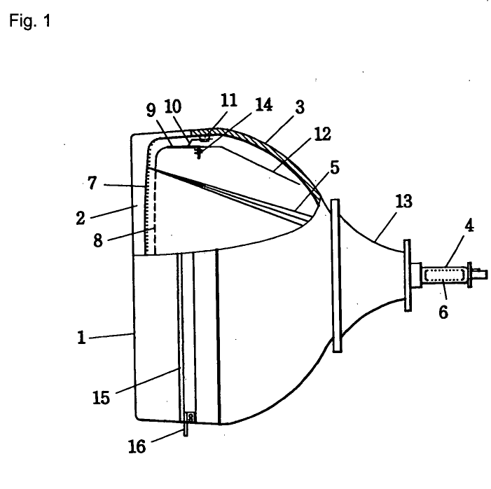

FIG. 2 shows a plane view illustrating longer axis, shorter axis and outermost distances of opposite angle of panel in accordance with the present invention.

FIG. 3 shows a graph for illustrating the variation of the weight accordance with the shape of panel of the present invention.

### DETAILED DESCRIPTION OF THE INVENTION

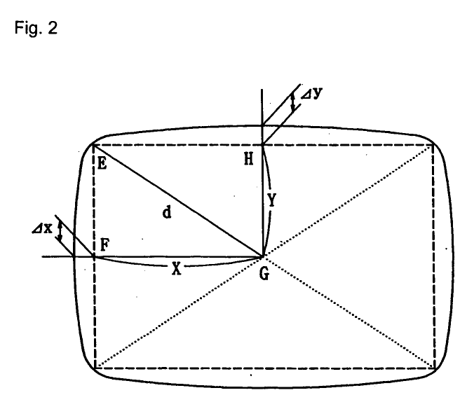

FIG. 2 shows a schematic plane view of a panel viewing from the front side for illustrating parameters of an embodiment of the present invention. In FIG. 2, a solid rectangular curve represents outline of the panel and a dotted rectangular represents effective screen of the panel. Hereinafter, the following parameters are used to describe an embodiment of the present invention.

d is length from a central point G to a diagonal vertex E of an effective screen of the panel.

Δx is length from a point F to an intersection of the outline of the panel and the longer axis X, wherein the point F is intersection of longer axis X and a shorter side of the effective screen of the panel.

X is length from the central point G of the effective screen to the point F.

Δy is length from a point H to an intersection of the outline of the panel and the shorter axis Y, wherein the point H is intersection of shorter axis Y and a longer side of the effective screen of the panel.

Y is length from the central point G of the effective screen to the point H.

### Embodiment 1

According to Embodiment 1 of the present invention, the effective screen has a horizontal and vertical ratio of 16:9 and satisfies Equation 1.

[(Δy/d)×100]≦5.65 Equation. 1

Preferably, the panel of the cathode ray tube according to Embodiment 1 of the present invention satisfies Equation 2 in addition to Equation 1.

[(Δy/Y)×100]≦11.50 Equation. 2

More preferably, the panel of the cathode ray tube according to Embodiment 1 of the present invention satisfies Equations 3 and 4 in addition to Equations 1 and 2.

[(Δx/d)×100]≦2.05 Equation. 3

[(Δx/X)×100]≦2.35 Equation. 4

Further, Embodiment 1 described hereinabove may be applied to a flat type color cathode ray tube where outer surface of panel is substantially flat. Therefore, the effect of the present invention is still effective for the flat type color cathode ray tube.

### Embodiment 2

According to Embodiment 2 of the present invention, the effective screen has a horizontal and vertical ratio of 4:3 and satisfies Equation 5.

[(Δy/d)×100]≦5.05 Equation. 5

Preferably, the panel of the cathode ray tube according to Embodiment 2 of the present invention satisfies Equation 6 in addition to Equation 5.

[(Δy/Y)×100]≦9.0 Equation. 6

More preferably, the panel of the cathode ray tube according to Embodiment 2 of the present invention satisfies Equations 7 and 8 in addition to Equations 5 and 6.

[(Δx/d)×100]≦2.95 Equation. 7

[(Δx/X)×100]≦3.5 Equation. 8

Further, Embodiment 2 described hereinabove may be applied to a flat type color cathode ray tube where outer surface of panel is substantially flat. Therefore, the effect of the present invention is still effective for the flat type color cathode ray tube.

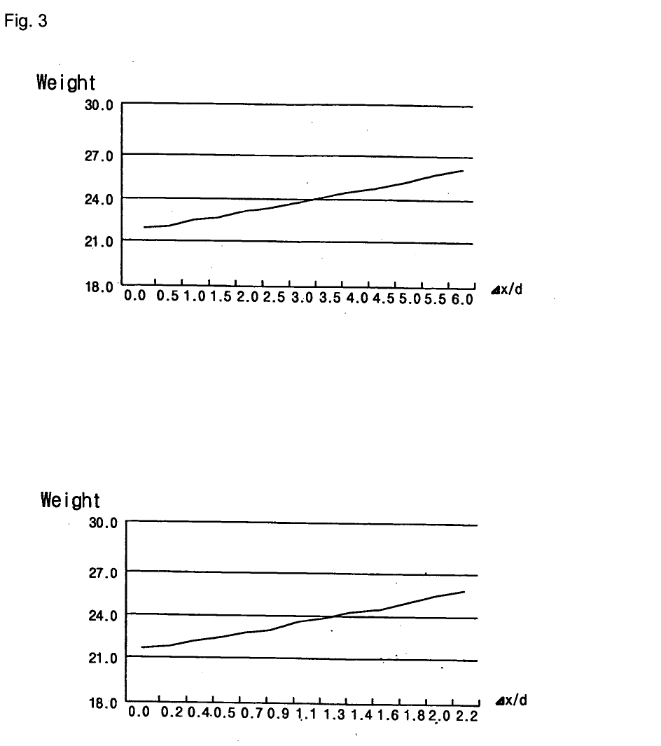

FIG. 3 shows a graph for illustrating variation of the weight of the panel according to the present invention.

In FIG. 3, variation of the weight of the panel is shown with respect to Δx/d, and Δy/d. As shown in FIG. 3, when Δx and Δy decrease with respect to d, the weight of the panel is reduced accordingly.

Table 1 shows the weight and cost of the panel with respect to the weight and cost of overall cathode ray tube according to the prior art and the present invention, for a panel having effective sreen of horizontal and vertical ratio of 16:9.

TABLE 1

| | | Conventional | | Conventional | | Boundary | | Embodiment | | Embodiment | |
|---|---|---|---|---|---|---|---|---|---|---|---|
| note | | example. 1 | | example. 2 | | data | | 1-1 | | 1-2 | |
| (Δx/d) × | (Δy/d) × | 2.45 | 6.05 | 2.25 | 5.85 | 2.05 | 5.65 | 1.85 | 5.45 | 1.65 | 5.25 |
| 100 | 100 | | | | | | | | | | |
| (Δx/X) × | (Δy/Y) × | 2.75 | 12.3 | 2.55 | 11.9 | 2.35 | 11.5 | 2.15 | 11.1 | 1.95 | 10.7 |
| 100 | 100 | | | | | | | | | | |

| | | | | | |
|---|---|---|---|---|---|
| Weight(kg) | 26.7 | 26.1 | 25.5 | 25.0 | 24.6 |
| Material costs(%) | 102.1 | 10.1 | 100 | 99.1 | 98.2 |

Table 2 shows the weight and cost of the panel with respect to the weight and cost of overall cathode ray tube according to the prior art and the present invention, for a panel having effective sreen of horizontal and vertical ratio of 4:3.

TABLE 2

| | | Conventional | | Conventional | | Boundary | | Embodiment | | Embodiment | |
|---|---|---|---|---|---|---|---|---|---|---|---|
| note | | example. 1 | | example. 2 | | data | | 2-1 | | 2-2 | |
| (Δx/d) × | (Δy/d) × | 3.35 | 5.45 | 3.15 | 5.25 | 2.95 | 5.05 | 2.75 | 4.85 | 2.55 | 4.65 |
| 100 | 100 | | | | | | | | | | |
| (Δx/X) × | (Δy/Y) × | 3.90 | 13.0 | 3.70 | 11.0 | 3.50 | 9.00 | 3.30 | 7.00 | 3.10 | 5.00 |
| 100 | 100 | | | | | | | | | | |

| | | | | | |
|---|---|---|---|---|---|
| Weight (kg) | 39.0 | 38.3 | 37.5 | 36.8 | 36.2 |
| Material costs (%) | 102.5 | 101.3 | 100 | 99.0 | 98.2 |

As shown in Tables 1 and 2, as the ratios Δx/d, Δy/d, Δx/X and Δy/Y decrease, the weight and cost of the panel in the weight and cost of the overall cathode ray tube are reduced.

Therefore, if the ratios Δx/d, Δy/d, Δx/X and Δy/Y increase, the weight and cost of the panel are increased, which means overall weight and cost of the cathode ray tube is increased too.

On the other hand, if the ratios decrease more than the ratios according to the embodiments of the present invention, the panel and funnel may be exploded by external shock.

### Industrial Applicability

According to the present invention, the panel of a color cathode ray tube have the optimum outer structure which provide characteristic of explosion proof while cutting down on expences and weight.

What is claimed is:

1. A cathode ray tube comprising:
a panel having an effective screen;
a funnel connected to the panel; and
an electron gun to generate electron beams; wherein
said effective screen has a horizontal and vertical ratio of 16:9; and
said panel satisfies a condition:
[(Δy/d)×100]≦5.65
wherein d is length from a central point G to a diagonal vertex E of said effective screen, and Δy is length from a point H to an intersection point of the outline of the panel and the shorter axis Y, the point H being intersection of shorter axis Y and a longer side of said effective screen.

2. The cathode ray tube of claim 1, wherein
said panel further satisties a condition:
[(y/Y)×100]≦11.50
wherein Y is length from the central point G of said effective screen to the point H.

3. The cathode ray tube of claim 1, wherein
said panel further satisties a condition:
[(Δx/d)×100]≦2.05
wherein Δx is length from a point F to an intersection point of the outline of the panel and the longer axis X, wherein the point F is intersection of longer axis X and a shorter side of said effective screen.

4. The cathode ray tube of claim 3, wherein
said panel further satisties a condition:
[(Δx/X)×100]≦3.5
wherein X is length from the central point G of said effective screen to the point F.

5. The cathode ray tube of claim 4, wherein
said panel further satisties a condition:
[(Δy/Y)×100]≦11.50.

6. The cathode ray tube of claim 1, wherein
outer surface of said panel is substantially flat.

7. A cathode ray tube comprising:
a panel having an effective screen;
a funnel connected to the panel; and
an electron gun to generate electron beams; wherein
said effective screen has a horizontal and vertical ratio of of 4:3; and
said panel satisfies a condition:
[(Δy/d)×100]≦5.05
wherein d is length from a central point G to a diagonal vertex E of said effective screen, and Δy is length from a point H to an intersection point of the outline of the panel and the shorter axis Y, the point H being intersection of shorter axis Y and a longer side of said effective screen.

8. The cathode ray tube of claim 7, wherein
said panel further satisties a condition:
[(Δy/Y)×100]≦9.0
wherein Y is length from the central point G of said effective screen to the point H.

9. The cathode ray tube of claim 7, wherein
said panel further satisties a condition:
[(Δx/d)×100]≦2.95
wherein Δx is length from a point F to an intersection point of the outline of the panel and the longer axis X, wherein the point F is intersection of longer axis X and a shorter side of said effective screen.

10. The cathode ray tube of claim 9, wherein
said panel further satisties a condition:
[(Δx/X)×100]≦3.5
wherein X is length from the central point G of said effective screen to the point F.

11. The cathode ray tube of claim 10, wherein
said panel further satisties a condition:
[(Δy/Y)×100]≦9.0

12. The cathode ray tube of claim 7, wherein
outer surface of said panel is substantially flat.
